(19) United States
(12) Patent Application Publication
(10) Pub. No.: US 2007/0223914 A1
(43) Pub. Date: Sep. 27, 2007

(54) Camera system

(75) Inventors: Kouhei Awazu, Asaka (JP); Atsushi Misawa, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,086

(22) Filed: Mar. 23, 2007

(30) Foreign Application Priority Data
Mar. 24, 2006 (JP) 2006-081892

(51) Int. Cl. G03B 17/00

(52) U.S. Cl. 396/529

(57) ABSTRACT

A camera system comprises: an imaging unit incorporating therein an imaging device, the imaging unit forming an image of a subject on the imaging device to generate image data; and a camera main frame on which the imaging unit is detachably mounted, the camera main frame receiving an image signal generated in the imaging device of the imaging unit to perform signal processing. The camera system has a turning mechanism that turns the imaging unit by turning the imaging unit which is mounted on the camera main frame.

### BACKGROUND OF THE INVENTION

1. Field of the Invention

The present invention relates to a camera system comprising: an imaging unit having an imaging device; and a camera main frame on which the imaging unit is detachably mounted, the camera main frame receiving an image signal generated in the imaging device of the imaging unit to perform signal processing.

2. Description of the Related Art

Recently, in the field of a digital camera, there is known a camera system in which an image taking lens is detachably mounted on a camera main frame (cf. for example Japanese Patent Application Laid Open Gazette TokuKai 2005-70711).

Moreover, there is proposed a camera system comprising: an imaging unit incorporating therein an imaging device; and a camera main frame on which the imaging unit is detachably mounted, the camera main frame receiving an image signal from the mounted imaging unit to perform signal processing (cf. for example Japanese Patent Application Laid Open Gazette TokuKai 2005-278076, and Japanese Patent Application Laid Open Gazette TokuKai 2005-278020).

By the way, for instance, in the event that it is desired to take a picture through maintenance of the same composition for a long time, or in the event that it is desired to take a picture of the souvenir picture by using the self-timer function, it is preferable to fix the camera main frame to a tripod and to take a picture.

In this case, the camera main frame is fixed to the tripod by the user, each leg of the tripod expands and contracts, and a rough composition is decided. Subsequently, a universal-head of the tripod is turned in a direction of a right and left swinging angle and a direction of an angle of elevation by the user, so that the composition is fine-tuned (hereinafter, an adjustment in a direction of a right and left swinging angle is referred to as a pan adjustment, and an adjustment in a direction of an angle of elevation is referred to as a tilt adjustment).

After the composition is decided, taking a picture is executed, so that image data is obtained.

However, when the subject moves by some chance, the composition once decided will be changed. Therefore, to try to decide the composition again, there is frequent such a case that time is taken in the operations of expansion and contraction of each leg of the tripod, and the pan adjustment and the tilt adjustment of the universal-head of the tripod. Therefore, the shutter chance might be missed.

According to the technology disclosed in Japanese Patent Application Laid Open Gazette TokuKai 2005-278020, there is proposed a camera system that enables taking a picture by remote control while confirming the composition of the subject projected on the display screen of the monitor.

This camera system comprises: an imaging unit incorporating therein an imaging device; and a camera main frame incorporating therein an operating section for controlling the imaging unit in remote control and a monitor screen on which a subject is displayed. This camera system has installed the sending and receiving unit that communicates between the imaging unit and the camera main frame in the imaging unit and the camera main frame, respectively. Therefore, it is easy to take a picture because the composition of subject can be confirmed with the camera main frame and the imaging unit separated when taking a picture of a low angle and a high angle not to match the line of vision easily to subject.

However, according to this camera system, when the subject moves by some chance, to try to decide the composition again, it is desirable to adjust the tripod installed in the imaging unit. In this case, the user has the camera main frame by one hand, and adjusts the tripod installed in the imaging unit while confirming the monitor screen prepared for in the camera main frame. Thus, there is a problem of rather taking time as compared with a case where the tripod is adjusted by both hands.

### SUMMARY OF THE INVENTION

In view of the foregoing, it is an object of the present invention to provide a camera system contributing to an improvement of operability when the composition is adjusted.

To achieve the above-mentioned objects, the present invention provides a first camera system comprising:

an imaging unit that incorporates therein an imaging device, the imaging unit forming an image of a subject on the imaging device to generate image data; and a camera main frame on which the imaging unit is detachably mounted, the camera main frame receiving an image signal generated in the imaging device of the imaging unit to perform signal processing,

wherein the camera system has a turning mechanism that turns the imaging unit by turning the imaging unit which is mounted on the camera main frame.

According to the first camera system of the present invention, the camera system has the turning mechanism that turns the imaging unit which incorporates therein the imaging device. This feature makes it possible for a user to readily perform the pan adjustment or the tilt adjustment for the imaging unit by simply turning the imaging unit, and thereby saving one trouble for adjustment of the tripod and the universal head.

In the first camera system according to the present invention as mentioned above, it is preferable that the camera system further has a flexible cover section that covers the turning mechanism while permitting an operation of the turning mechanism.

Having the cover section makes it possible that the turning mechanism is not seen, and it is excellent in the design and high quality can be impressed.

To achieve the above-mentioned objects, the present invention provides a second camera system comprising: an imaging unit that incorporates therein an imaging device, the imaging unit forming an image of a subject on the imaging device to generate image data; and a camera main frame on which the imaging unit is detachably mounted, the camera main frame receiving an image signal generated in the imaging device of the imaging unit to perform signal processing,

wherein the camera system has an attitude variable mechanism that changes attitude of the imaging unit mounted on the camera main frame between a first attitude wherein the imaging unit turns to the subject against the back of the camera main frame and a second attitude wherein the side of the imaging unit approaches the subject side of the camera main frame.

According to the second camera system of the present invention, the camera system has the attitude variable mechanism that changes attitude of the imaging unit mounted on the camera main frame between the first attitude and the second attitude. This feature makes it possible for a user to readily perform the pan adjustment or the tilt adjustment for the imaging unit by simply turning the imaging unit, and thereby saving one trouble for adjustment of the tripod and the universal head.

Thus, when the imaging unit takes the second attitude, it is possible to contribute to a miniaturization of the camera system, and thereby emphasizing storage and the portability.

In the camera system according to the present invention as mentioned above, it is preferable that the camera system further has a flexible cover section that covers the attitude variable mechanism while permitting an operation of the attitude variable mechanism.

Having the cover section makes it possible that the attitude variable mechanism is not seen, and it is excellent in the design and high quality can be impressed.

In the camera system according to the present invention as mentioned above, it is preferable that the imaging unit has a mounting section that is in charge of coupling with the camera main frame, and an imaging unit main frame in which a coupling structure with the mounting section serves as the attitude variable mechanism, and the imaging unit is drawn out forward of an optical axis direction while the mounting section is left in a state that the imaging unit is mounted on the camera main frame, so that the imaging unit changes to the second attitude.

In the event that it is difficult to directly turn the imaging unit from the first attitude to the second attitude in view of the structure of the camera system, the imaging unit is drawn out forward of an optical axis direction and then the imaging unit changes to the second attitude. This feature makes it possible to contribute to a miniaturization of the camera system, and thereby emphasizing storage and the portability.

In the camera system according to the present invention as mentioned above, it is preferable that the camera system has a sensor that detects whether the imaging unit takes the first attitude or the second attitude, and power source control means for controlling a power source in accordance with a detection result of the sensor in such a way that the power source is turned on when the first attitude and turned off when the second attitude.

Having the power source control means makes it possible to avoid useless power consumption because the power supply is automatically turned off in the state that exists in the second attitude.

To achieve the above-mentioned objects, the present invention provides a third camera system comprising: an imaging unit incorporating therein an imaging device, the imaging unit forming an image of a subject on the imaging device to generate image data; and a camera main frame on which the imaging unit is detachably mounted, the camera main frame receiving an image signal generated in the imaging device of the imaging unit to perform signal processing,

wherein the camera system has:

the imaging unit incorporating therein the imaging device, the imaging unit forming an image of a subject on the imaging device to generate image data;

the camera main frame that receives the image signal from the imaging unit to perform signal processing; and

an intermediate member that turns the imaging unit, the intermediate member being interposed between the imaging unit and the camera main frame so that the imaging unit is detachably mounted on the camera main frame, and being adapted for turning the imaging unit.

According to the third camera system of the present invention, the camera system has the intermediate member that turns the imaging unit. This feature makes it possible for a user to readily perform the pan adjustment or the tilt adjustment for the imaging unit by simply turning the imaging unit.

In the third camera system according to the present invention as mentioned above, it is preferable that the camera system further has a flexible cover section that covers the intermediate member while permitting an operation of the intermediate member.

Having the cover section makes it possible that the intermediate member is not seen, and it is excellent in the design and high quality can be impressed.

In the camera system according to the present invention as mentioned above, it is preferable that the intermediate member has an attitude variable mechanism that changes attitude of the imaging unit mounted on the camera main frame via the intermediate member between a first attitude wherein the imaging unit turns to the subject against the back of the camera main frame and a second attitude wherein the side of the imaging unit approaches the subject side of the camera main frame.

Thus, when the imaging unit takes the second attitude, it is possible to contribute to a miniaturization of the camera system, and thereby emphasizing storage and the portability.

In the camera system according to the present invention as mentioned above, it is preferable that the intermediate member has a first mounting section that is in charge of coupling with the camera main frame, a second mounting section that is in charge of coupling with the imaging unit, and a coupling structure that serves as the attitude variable mechanism, wherein the second mounting section is drawn out forward of an optical axis direction while the first mounting section is left in a state that the imaging unit is mounted on the camera main frame via the intermediate member, so that the imaging unit changes to the second attitude.

In the event that it is difficult to directly turn the imaging unit from the first attitude to the second attitude in view of the structure of the camera system, in a similar fashion to that of the first camera system, the imaging unit is drawn out forward of an optical axis direction and then the imaging unit changes to the second attitude. This feature makes it possible to contribute to a miniaturization of the camera system, and thereby emphasizing storage and the portability.

In the third camera system according to the present invention as mentioned above, it is preferable that the intermediate member has a sensor that detects whether the imaging unit takes the first attitude or the second attitude, and the camera system has power source control means for controlling a power source in accordance with a detection result of the sensor in such a way that the power source is turned on when the first attitude and turned off when the second attitude.

Having the power source control means makes it possible to avoid useless power consumption because the power supply is automatically turned off in the state that exists in the second attitude.

As mentioned above, according to the present embodiment, there is provided a camera system capable of contributing to an improvement of operability in adjustment.

### BRIEF DESCRIPTION OF THE DRAWINGS

FIG. 1 is a perspective view of a camera system according to a first embodiment of a first camera system of the present invention.

FIG. 2 is a rear elevation of the camera system shown in FIG. 1.

FIG. 3 is a perspective view of an imaging unit of the first camera system.

FIG. 4 is a structural view of a mounting section of the camera main frame.

FIG. 5 is an explanatory view useful for understanding a state that a connector section of the imaging unit is detachably mounted on the mounting section of the camera main frame.

FIG. 6 is a block diagram of the camera system wherein the imaging unit is mounted on the camera main frame.

FIG. 7 is a perspective view of a camera system according to a second embodiment of the first camera system of the present invention.

FIG. 8 is a front view of a cover section at the side for connection with the camera main frame.

FIG. 9 is an explanatory view useful for understanding an attitude variable mechanism of the camera system.

FIG. 10 is a perspective view of a camera system according to a first embodiment of the second camera system of the present invention, having a cover section.

FIG. 11 is an explanatory view useful for understanding a power source control means.

FIG. 12 is an explanatory view useful for understanding a state that the imaging unit is mounted on the camera main frame via the intermediate member.

FIG. 13 is an explanatory view useful for understanding an attitude variable mechanism of the imaging unit.

### DETAILED DESCRIPTION OF PREFERRED EMBODIMENTS

Embodiments of the present invention will be described with reference to the accompanying drawings.

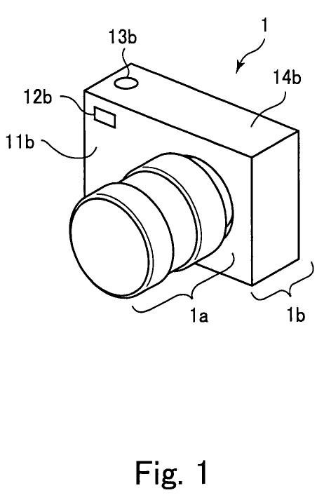

FIG. 1 is a perspective view of a camera system according to a first embodiment of a first camera system of the present invention.

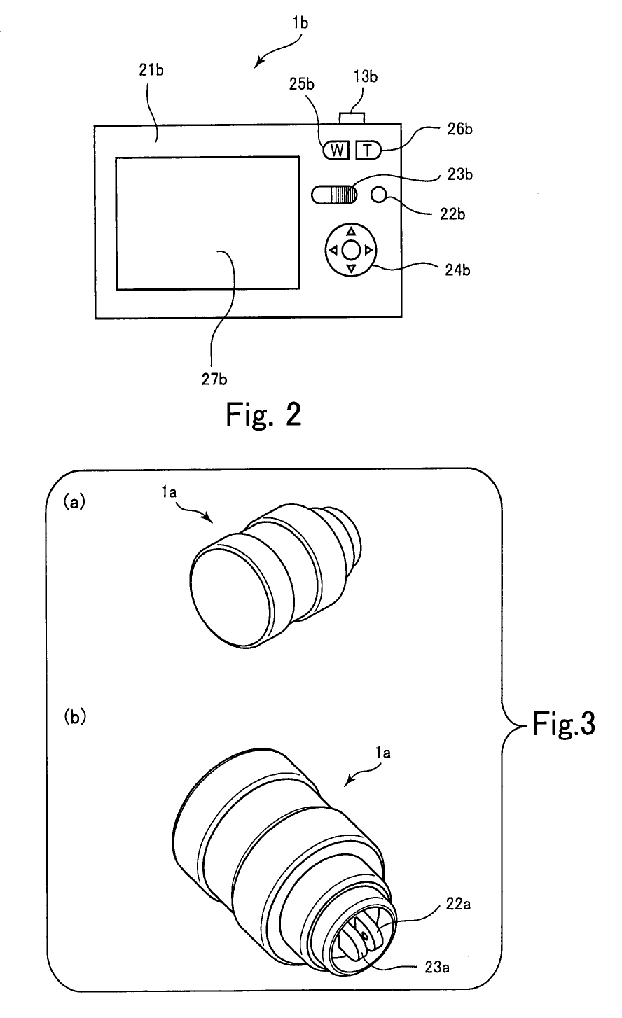

FIG. 2 is a rear elevation of the camera system shown in FIG. 1.

As seen from FIG. 1, a camera system 1 comprises: an imaging unit 1a having an image taking optical system and an imaging device; and a camera main frame 1b on which the imaging unit 1a is detachably mounted, the camera main frame 1b being adapted to perform a signal processing upon receipt of an image signal from the imaging unit 1a.

In a front side 11b of the camera main frame 1b, there is provided a flash luminescence window 12b for emitting flash aiming at subject.

In an upper side 14b of the camera main frame 1b, there is provided a release button 13b. When the release button 13b is depressed, the still picture image taking is performed.

As seen from FIG. 2, in a back side 21b of the camera main frame 1b, there are provided a power source button 22b and a mode switch 23b. The power source button 22b turns on and off a power source of the camera system 1. The mode switch 23b is a switch that switches a shooting mode and a reproduction mode.

Moreover, in the back side 21b of the camera main frame 1b, there is provided a menu switching and execution key 24b. The menu switching and execution key 24b is a key that freely switches a menu used to take a picture, selects the setting condition, and executes it.

Still moreover, in the back side 21b of the camera main frame 1b, there are provided a wide angle zoom key 25b, a telephoto zoom key 26b, and an LCD panel 27b. The wide angle zoom key 25b is a key to change the focal length to a wide angle side. The telephoto zoom key 26b is a key to change the focal length to a telephoto side. The LCD panel 27b displays an image of the subject, and menus of the menu switching and execution key 24b.

FIG. 3 is a perspective view of an imaging unit of the first camera system.

A part (a) of FIG. 3 is a perspective view of the imaging unit 1a wherein the imaging unit 1a is seen from the diagonal front side, and a part (b) of FIG. 3 is a perspective view of the imaging unit 1a wherein the imaging unit 1a is seen from the diagonal rear side.

As seen from the part (b) of FIG. 3, the imaging unit 1a is provided with connecting sections 22a and 23a for connection with the camera main frame 1b when the imaging unit 1a is mounted on the camera main frame 1b. The internal structure of the imaging unit 1a will be explained later.

Next, there will be explained the turning mechanism of the imaging unit 1a.

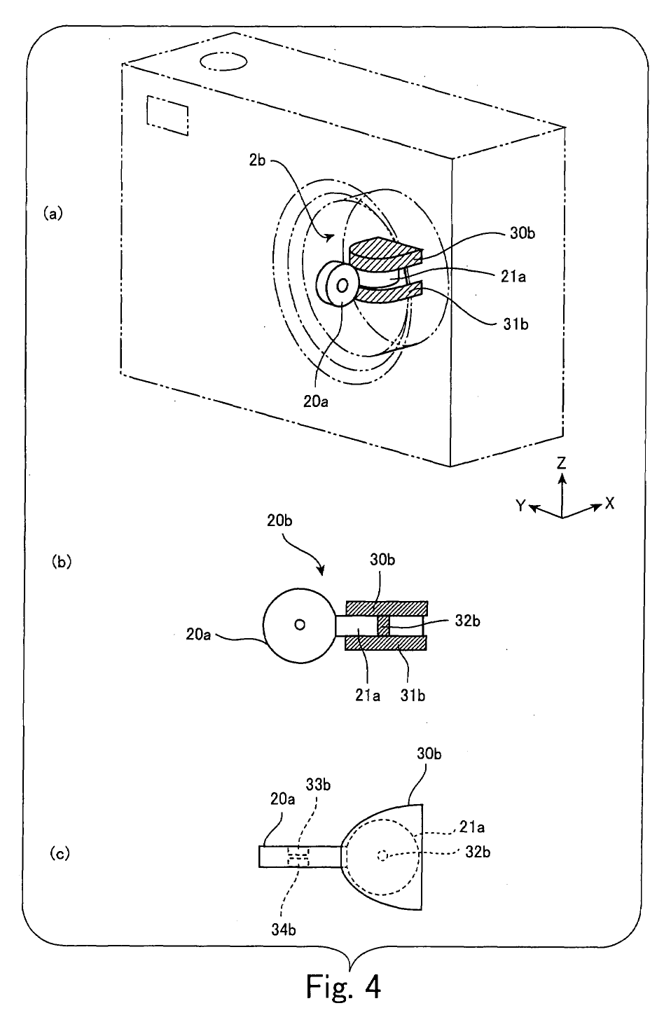

FIG. 4 is a structural view of a mounting section of the camera main frame.

As shown in the part (a) of FIG. 4, the camera main frame 1b is provided with a mounting section 2b for turning the imaging unit 1a.

The connecting sections 22a and 23a of the imaging unit 1a are connected to the mounting section 2b of the camera main frame 1b.

A part (b) of FIG. 4 is a sectional view of the mounting section 2b seen from the direction of y shown in the part (a) of FIG. 4. A part (c) of FIG. 4 is a sectional view of the mounting section 2b seen from the direction of z shown in the part (a) of FIG. 4.

As shown in the part (b) of FIG. 4, a turning section 21a of a turning material 20a is placed between a first projection section 30b and a second projection section 31b, so that the turning material 20a may freely turn right and left by centering on a turning shaft 32b.

Next, there will be explained a structure in which the imaging unit 1a is detachably mounted on the camera main frame 1b.

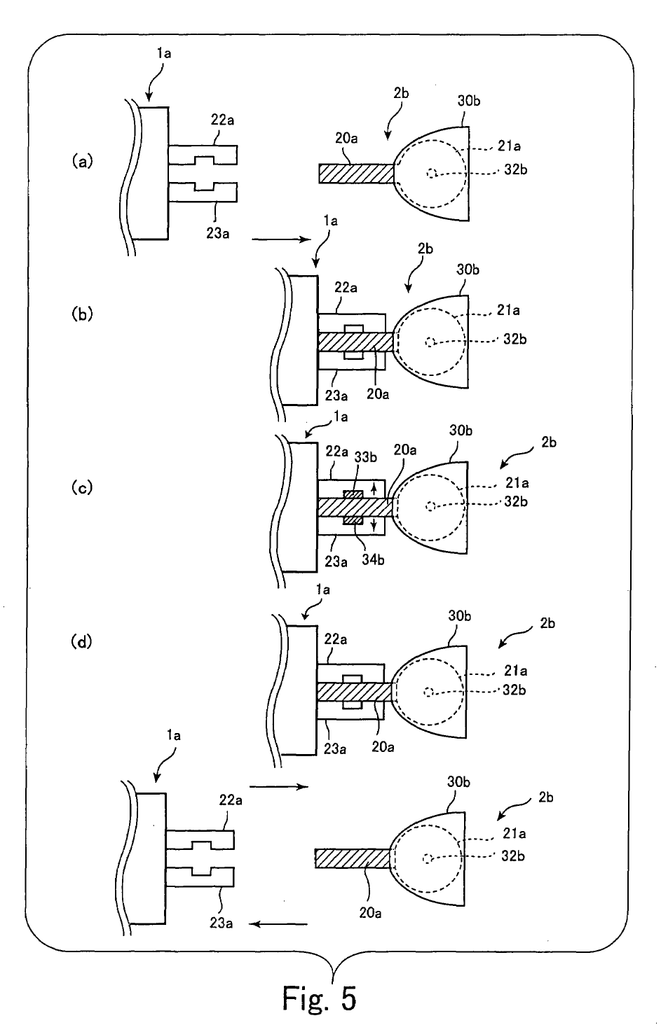

FIG. 5 is an explanatory view useful for understanding a state that a connector section of the imaging unit is detachably mounted on the mounting section of the camera main frame.

First of all, the connecting sections 22a and 23a of the imaging unit 1a, which are in the state of a part (a) of FIG. 5, are set in the turning material 20a of the mounting section 2b (a part (b) of FIG. 5).

The mounting section 2b is provided with a sensor (not illustrated) for sensing installation of the connecting sections 22a and 23a. When the sensor detects that the connecting sections 22a and 23a of the imaging unit 1a is set in the mounting section 2b, imaging unit connecting pins 33b and 34b are projected from the turning material 20a so that the imaging unit 1a is detachably mounted on the camera main frame 1b (a part (c) of FIG. 5).

As will be described later, the detachably mounting of the imaging unit 1a on the camera main frame 1b enables the electrical connection between those.

Thus, the detachably mounting of the imaging unit 1a on the camera main frame 1b makes it for a user to perform the pan adjustment or the tilt adjustment for the imaging unit 1a.

On the other hand, in the event that the imaging unit 1a is removed, the menu switching and execution key 24b is used to select a mode “removal of imaging unit”, so that the imaging unit connecting pins 33b and 34b are saved in the turning material 20a (a part (d) of FIG. 5).

Thus, the user can remove the imaging unit 1a (a part (e) of FIG. 5).

Next, there will be explained the internal structure of the camera system 1 according to the first embodiment in the first camera system.

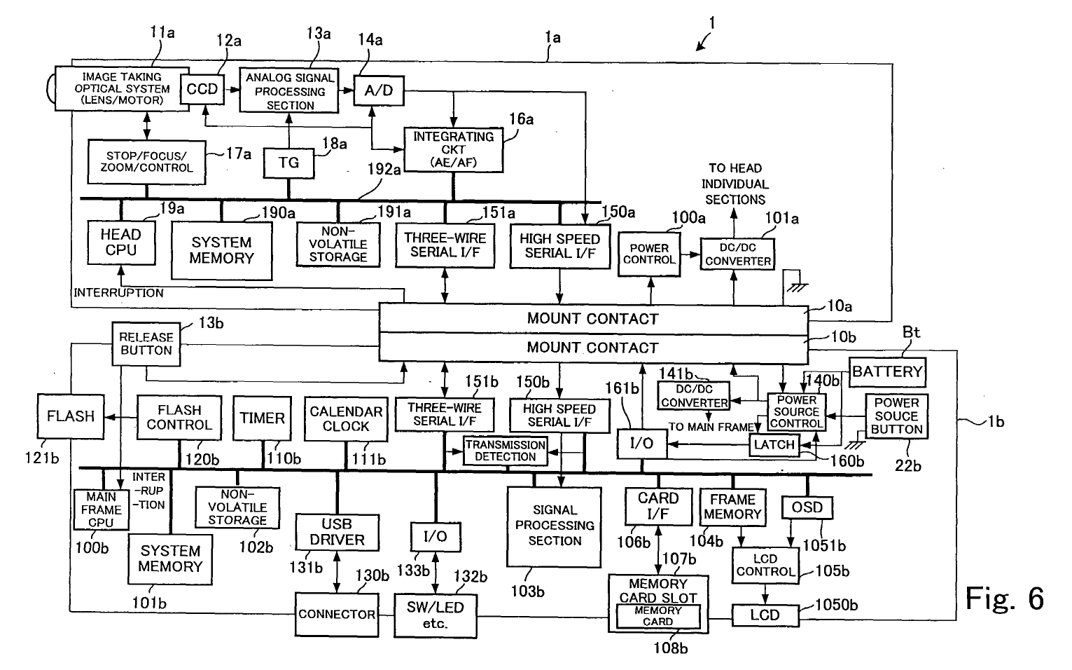

FIG. 6 is a block diagram of the camera system wherein the imaging unit is mounted on the camera main frame.

The structure of the imaging unit 1a is shown on an upper side of FIG. 6, and the structure of the camera main frame 1b is shown on a lower side of FIG. 6.

First of all, there will be simply explained the structure of the camera system 1.

The imaging unit 1a, which constitutes the camera system 1 of the present embodiment, only operates upon receipt of power supply from a battery Bt at the side of the camera main frame 1b, when the imaging unit 1a is mounted on the camera main frame 1b.

A DC/DC converter 101a on the imaging unit 1a is controlled together with a DC/DC converter 141b on the main frame side by an electric power control section 140b on the camera main frame 1b side. The DC/DC converter is a circuit that converts the voltage of the direct current electric power, and the one used by making the power-supply voltage down or making it rise.

When the power source button 22b shown in FIG. 2 is turned on in a state that the imaging unit 1a is mounted on the camera main frame 1b, electric power of the battery is supplied from the electric power control section 140b via the DC/DC converter 141b to individual sections of the camera main frame 1b.

Moreover, when the instruction of the power supply is transmitted from the electric power control section 140b on the camera main frame 1b side to an electric power control section 10a on the imaging unit 1a side through a latch section 160b and an I/O section 161b, the battery electric power is supplied to individual sections on the imaging unit 1a side through the DC/DC converter 101a.

When entering the state that imaging unit 1a is mounted on the camera main frame 1b, a low signal (grand level) is supplied from the imaging unit 1a side to the electric power control section 140b on the camera main frame 1b side. If the instruction of turning on the power supply is issued by the power source button 22b, the latch section 160b is switched by the electric power control section 140b on the camera main frame 1b side from low to high or from high to low, and a latch signal be supplied to the I/O section 161b. In addition, an instruction for turn-on of the power supply is transmitted from the I/O section 161b to the electric power control section 140b of the imaging unit 1b side. In other words, when the power source button 22b turns on through an operation of the mode dial, electric power is supplied to individual sections from the DC/DC converter 141b on the camera main frame 1b side, and the DC/DC converter 101a on the imaging unit 1a side, so that the camera system operates.

Next, there will be explained a flow of an image signal to be transmitted from the imaging unit 1a to the camera main frame 1b where the power supply turns on, and the camera system operates to take a picture.

There will be explained a structure of the interface (Hereafter, it is called I/F) on the imaging unit side and a structure of the I/F on the camera main frame side one by one while explaining the flow of the image signal.

First of all, there will be explained the structure of the imaging unit 1a side.

As shown in FIG. 6, the imaging unit 1a constituting the camera system 1 has an image taking optical system 11a and an imaging device (hereinafter it is referred to as CCD, since the CCD imaging device is used here) 12a. The image taking optical system 11a incorporates therein an image taking lens and an aperture. The image taking lens of the image taking optical system 11a is used to form an image of the subject on the CCD 12a, so that the CCD 12a generates image data. The image data generated by the CCD 12a is fed to an analog signal processing section 13a so as to apply the noise reduction processing. Thereafter, an A/D section 14a converts an image signal of the analog signal to an image signal of a digital signal, and then supplies the digital image signal to a high speed serial I/F 150a. The digital image signal is transmitted via the high speed serial I/F 150a and a high speed serial I/F 150b of the camera main frame 1b to the camera main frame 1b side.

As mentioned above, since the camera system is constructed in such a manner that one imaging unit of two or more kinds of imaging units is mounted on one of two or more kinds of camera main frames, the camera main frame, at the time when the imaging unit is mounted on the camera main frame, is in such a situation that it is not understood at all as to kinds of the imaging device of the imaging unit and the communication specification of the communication I/F of the imaging unit side. Thus, according to the present embodiment, when the imaging unit 1a is mounted on the camera main frame 1b and the power source turns on, a CPU 100b (which will be described later) of the camera main frame side controls a three-line serial interface 151b on the camera main frame side, and transmits to the imaging unit 1a information (hereinafter it is referred to as configuration information) as to the electric connection of CCD of the imaging unit 1a and transmission request of the communication specification. While details will be described, when a head CPU 19a of the imaging unit 1a sends back those information through three-line serial I/F 151a and 151b in response to the configuration information on the CCD 12a from the camera main frame 1b side and the transmission request of the communication specification, the main frame CPU 100b of the camera main frame 1b sets the transmission rate of high-speed serial I/F 150a and 150b in accordance with the communication specification.

According to the present embodiment, the main frame CPU 100b becomes a subject to set the transmission rate of the high-speed serial I/F 150a on the imaging unit 1a side as well as the high-speed serial I/F 150b on the camera main frame side.

After the main frame side CPU 100b sets up the transmission rates of the high-speed serial I/F 150a and the high-speed serial I/F 150b, the image signal is fed via the high-speed serial I/F 150a and the high-speed serial I/F 150b to a signal processing section 103b of the camera main frame 1b. In the image signal supplied to the camera main frame side, there are three kinds of image signals, such as an image signal (hereinafter it is referred to as a through picture signal) for a through picture to display on an LCD panel 27b the subject that is caught by the image taking lens in the imaging optical system when it is in state that either of shooting mode is selected with the mode switch 23b shown in FIG. 2, an image signal (hereinafter it is referred to as a still picture signal) representative of a still picture that is obtained through an operation of the release button 13b when it is in state that the still picture shooting mode is selected from among the shooting modes, and an image signal (hereinafter it is referred to as a dynamic picture signal) representative of a dynamic picture that is obtained through an operation of the release button 13b when it is in state that the dynamic picture shooting mode is selected from among the shooting modes.

The image signal, which is converted by the A/D section 14a into the digital, is also fed to an integrating circuit 16a provided after the A/D section 14a. The integrating circuit 16a operates in synchronism with a timing signal generated from a timing generator (hereinafter it is referred to as TG) 18a. The TG 18a is controlled by the head CPU 19a. The head CPU 19a controls the TG 18a and a stop/focus/zoom control section 17a in accordance with the procedure of the program stored in the system memory 190a. The system memory 190a stores a program indicative of processing procedure of AE and AF, and processing procedure related to the transmission on the serial bus. This program includes a through picture processing program which is activated when the shooting mode is selected by the mode dial, and then the still picture shooting mode, a still picture processing program, and a dynamic picture processing program which is activated when the dynamic picture shooting mode is selected. The head CPU 19a controls an operation of the integrating circuit 16a, an operation of the TG 18a, read/write operations of a non-volatile storage 191a, an operation of a three-wire serial driver 151a, and an operation of a high speed serial driver 150a in accordance with the processing procedures as mentioned above.

Thus, when the imaging unit 1a is mounted on the camera main frame 1b, the imaging unit 1a uses the three-wire serial I/F to transmit to the camera main frame 1b the configuration information and the communication specification in accordance with request of the camera main frame, and informs the camera main frame 1b of the specification of the CCD 12a of the imaging unit 1a and the communication specification of the imaging unit 1a, and thereafter supplies the image signal generated on the CCD 12a to the camera main frame 1b using the high speed serial I/F.

The above-mentioned description is concerned with the structure of the imaging unit 1a.

Next, there will be explained a structure for performing signal processing transmitted from the imaging unit 1a, in the camera main frame 1b.

The operation of the camera main frame 1b is controlled by the main frame CPU 100b. The camera main frame 1b is also provided with a system memory 101b that stores a program, and a non-volatile storage 102b that stores on writable and non-volatile basis ID information and signal processing information, which are transmitted from the camera main frame 1b side. The system memory 101b stores a program indicative of a procedure of the main processing of the camera system. This program also describes a processing procedure wherein the through picture signal is processed in cooperation with the head CPU 19a on the camera head 1a side, a processing procedure wherein the still picture signal is processed, and a processing procedure wherein the dynamic picture signal is processed.

The camera main frame 1b is provided with a signal processing section 103a. Configuration information that is transmitted from the imaging unit via the three-wire serial I/F on the imaging unit side and the three-wire serial I/F on the camera main frame side is set to the signal processing section 103b. In order that the main frame CPU 100b sets the configuration information to the signal processing section 103b, the three-wire serial I/F 151b is controlled when the power source turns on, so that a transmission request of the configuration information on the imaging unit 1a side is transmitted to the imaging unit 1a, and the three-wire serial I/F 151b receives the configuration information when the configuration information is returned from the imaging unit 1a. In this way, the received configuration information is set to the signal processing section 103b. Further, according to the present embodiment, the three-wire serial I/F 151b is used and the main frame CPU 10b, which also serves as an interface set up section, sets up a communication speed of the high speed serial I/F 150a of the imaging unit 1a and a communication speed of the high speed serial I/F 150b of the camera main frame 1b, so that the image signal, which is transmitted via both the high speed serial I/F 150a and the communication speed of the high speed serial I/F 150b, can be fed to the signal processing section 103b as soon as possible.

The three-wire serial I/F 151a on the imaging unit side and the three-wire serial I/F 151b on the camera main frame side are provided on any imaging unit and any camera main frame on a common basis, and the communication specification of the three-wire serial I/F on the imaging unit side matches that of the three-wire serial I/F on the camera main frame side. Accordingly, even if which imaging unit is mounted on which camera main frame, the use of both three-wire serial I/F 151a and 151b makes it possible to refer to the communication specification of the high-speed serial I/F that is the first head side I/F of the imaging unit side, and configuration information on CCD of the imaging unit. In the event that the common communication specification between the imaging unit and the camera main frame is detected through making reference, the main frame CPU sets the common communication specification to both the communication I/F so that the image signal, that is generated with the CCD of the imaging unit, is supplied from the imaging unit side to the camera main frame side. Thus, the signal processing section of the camera main frame performs the signal processing according to the configuration specification on the CCD.

Thus, according to the present embodiment, the camera main frame 1b side can performs the signal processing according to the configuration specification for the CCD 12a of the imaging unit 1a that is interchangeably mounted, to meet the communication specification of the CCD 12a of the imaging unit 1a and the high-speed serial I/F. Accordingly, it is possible to immediately perform the display of the through picture when the power source turns on.

Here, the talk is returned to the flow of the image signal, and it explains the processing of the image signal since the signal processing section on the camera main frame side.

As mentioned above, according to the present embodiment, any one of three kinds of image signals of the through picture signal, the still picture signal and the dynamic picture signal is transmitted from the imaging unit 1a to the camera main frame 1b side. Accordingly, for instance, in case of the through picture signal, the signal processing section 103b applies processing to the through picture signal, and the processed image signal is fed via the frame memory 104b to an LCD control section 105b and the LCD panel 27b as well, so that the through picture according to the through picture signal is displayed on the LCD display screen. The LCD control section 105b also receives information from OSD (On Screen Display) 1051b side so that there is displayed selection menu as well as the through picture.

When an operator depresses the release button 13b while looking the through picture, the still picture signal generated by the CCD 12a is supplied to the signal processing section 103b so as to be subjected to the signal processing, and the still picture signal, which is subjected to JPEG compression processing, is recorded on a memory card 108b mounted on a memory card slot 107b via a card I/F 106b.

When the signal processing section 103b applies processing to the dynamic picture signal, the image signal, which is subjected to MPEG compression processing, is recorded on the memory card 108b mounted on the memory card slot 107b via the card I/F 106b.

Thus, the high-speed serial I/F transmits the image signal to the camera main frame side in short time, so that the signal processing section 103b of the camera main frame 1b applies the signal processing to the image signal to meet the configuration of the CCD 12a of the imaging unit 1a.

The above-mentioned description is concerned with the flow of the image signal.

Next, there will be explained the structure of other structural parts of the camera main frame 1b.

The camera main frame 1b further comprises: in addition to the section for performing the processing of the image signal, timer 110b and calendar clock 111b which create data for displaying time and date information on the LCD panel 27b via the OSD 1051b; USBI/F 131b and USB connector 130b which are for connection with an external equipment; and a switch/LED 132b for giving an operating instruction to the camera system and for performing a simplified display. The operating instruction of the switch is supplied via an I/O 133b to the main frame CPU 100b to perform the processing according to the operating instruction. Here, the release button 13b is directly connected to both interruption terminals of the main frame CPU 100b and the head CPU 19a. Thus, when the release button 13b is depressed, both the main frame CPU 100b and the head CPU 19a are operable in an interruption mode so that the still picture processing program or the dynamic picture processing program is activated.

Thus, an operator can simply perform the pan adjustment and the tilt adjustment by turning the imaging unit, and thereby contributing to an improvement of operability of the camera system while saving electric power consumption.

The explanation of the camera system that is the first embodiment of the first camera system is ended above.

Next, there will be explained a camera system that is the second embodiment of the first camera system.

In the camera system that is the second embodiment of the first camera system, the same parts are denoted by the same reference numbers as those of the camera system that is the first embodiment of the first camera system, and redundant explanation will be omitted.

The camera system that is the second embodiment of the first camera system is the same as the camera system that is the first embodiment of the first camera system in the turning mechanism, but having a flexible cover section for covering the turning mechanism.

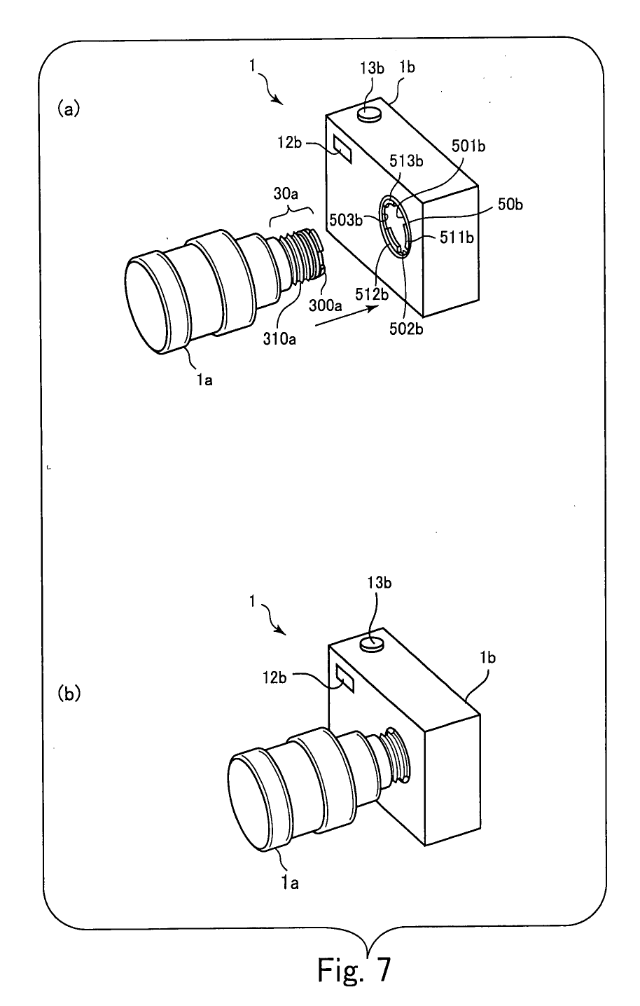

FIG. 7 is a perspective view of a camera system according to the second embodiment of the first camera system of the present invention.

A part (a) of FIG. 7 shows a state in which the camera main frame 1b is separated from the imaging unit 1a.

The imaging unit 1a has a cover section 30a.

The cover section 30a has a cylindrical elasticity material 310a which expands and contracts, and is free in bending, and a connection section 300a that connects with the camera main frame 1b.

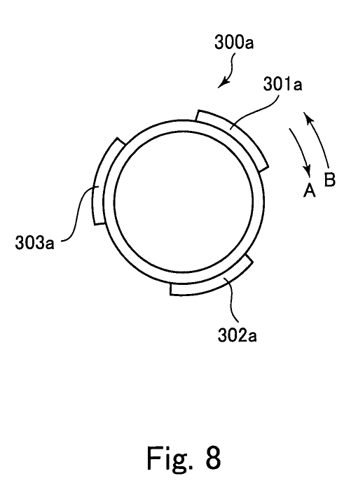

FIG. 8 is a front view of a cover section on the side for connection with the camera main frame.

As shown in FIG. 8, the connection section 300a has clicks 301a, 302a, and 303a adapted for detachably mounting on the camera main frame 1b.

On the other hand, in front side 11b of the camera main frame 1b, as shown in a part (a) of FIG. 7, there is provided a support member 50b that supports the imaging unit 1a.

The support member 50b has notches 501b, 502b, and 503b for detaching the imaging unit 1a have. Moreover, the support member 50b has clicks 511b, 512b, and 513b to connect with the imaging unit 1a and to support it.

Next, there will be explained an operation in which an operator mounts the imaging unit 1a on the camera main frame 1b.

First of all, a user pushes the clicks 301a, 302a, and 303a that are installed in the cover section 30a of the imaging unit into the notches 501b, 502b, and 503b of the camera main frame 1b. At that time, first of all, the connecting sections 22a and 23a of the imaging unit 1a shown in the part (a) of FIG. 3 are mounted on the mounting section 2b of the camera main frame 1b. Next, as shown in FIG. 8, when the connection section 300a of the imaging unit 1a is turned in a direction A, the imaging unit 1a is mounted on the camera main frame 1b. When the connection section 300a of the imaging unit 1a is returned to a direction B, the imaging unit 1a can be removed from the camera main frame 1b. A part (b) of FIG. 7 is a view showing a state after the imaging unit 1a, which is provided with the cover section 30a, is mounted on the camera main frame 1b.

Thus, in a similar fashion to that of the camera system that is the first embodiment of the first camera system, which has been already explained, a user can turn around the imaging unit by turning the imaging unit, and whereby taking a picture becomes possible. Having the cover section 30a makes it possible that the turn mechanism mentioned above is not seen, and it is excellent in the design and high quality can be impressed.

The explanation of the camera system that is the second embodiment of the first camera system is ended above.

Next, there will be explained a camera system that is the first embodiment of the second camera system.

In the camera system that is the first embodiment of the second camera system, the same parts are denoted by the same reference numbers as those of the camera system that is the first embodiment of the first camera system, and redundant explanation will be omitted.

The camera system that is the first embodiment of the second camera system has an attitude variable mechanism that changes attitude between a first attitude wherein the imaging unit turns to the subject against the back of the camera main frame and a second attitude wherein the side of the imaging unit approaches the subject side of the camera main frame.

In a similar fashion to that of the camera system that is the first embodiment of the first camera system, also in the camera system that is the first embodiment of the second camera system, the imaging unit 1a is mounted on the camera main frame 1b. Turning of the imaging unit 1a by a user makes it possible to perform the pan adjustment and the tilt adjustment.

Next, there will be explained an attitude variable mechanism of the imaging unit 1a of the camera system that is the first embodiment of the second camera system.

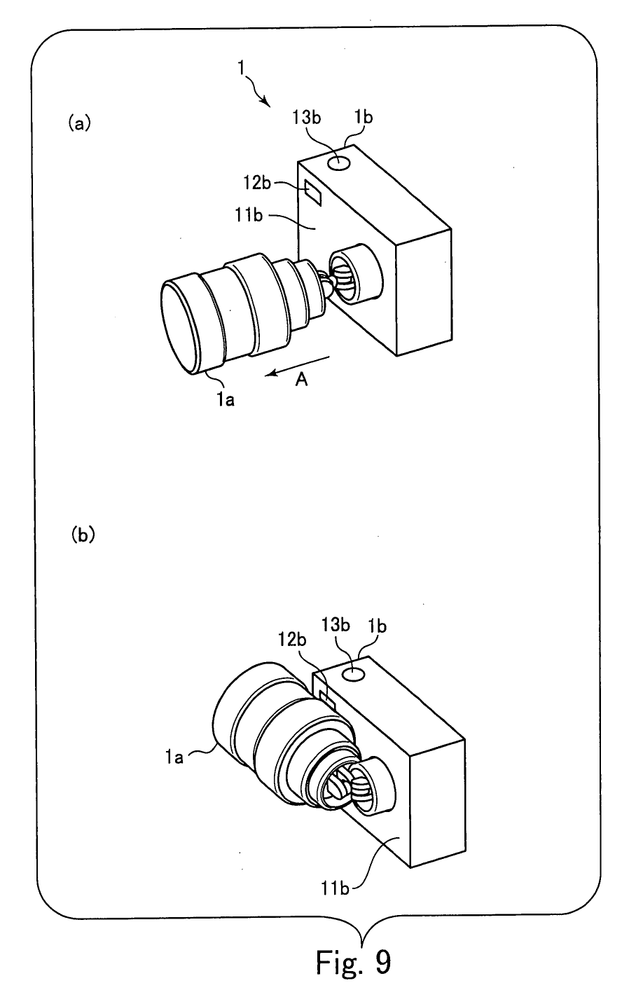

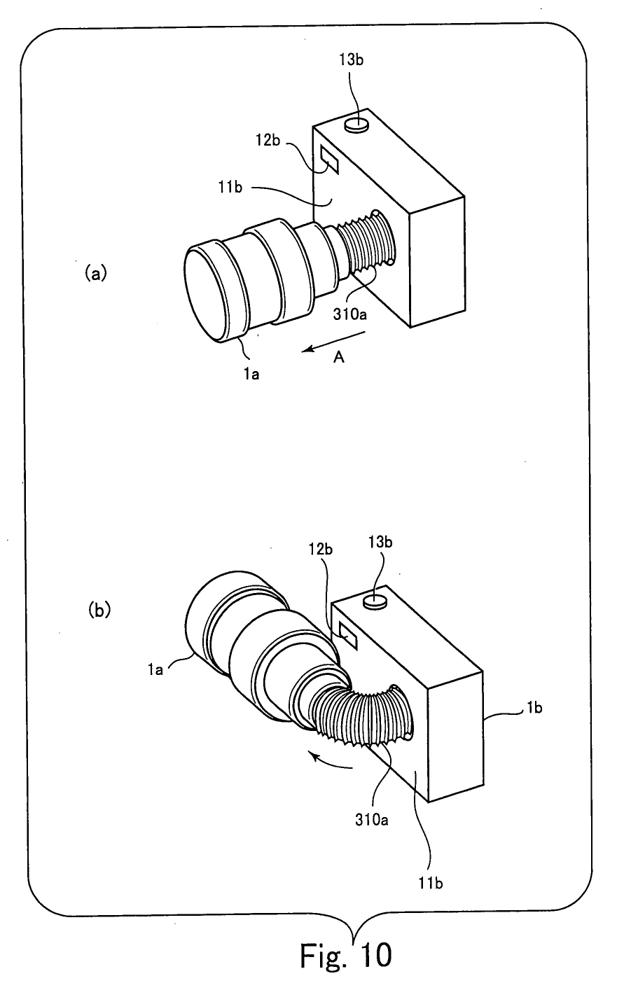

FIG. 9 is an explanatory view useful for understanding an attitude variable mechanism of the camera system.

When a user draws out the imaging unit 1a of the camera system 1, which takes the first attitude, in the direction of arrow A, as shown in a part (a) of FIG. 9, the imaging unit 1a is drawn out forward of the optical axis direction while a joint is left in a state that the mounting section 2b and the imaging unit 1a are mounted on the camera main frame 1b.

Next, it is bent by about 90 degrees by the user so that the side of the imaging unit 1a is adjacent to the front side 11b of the camera main frame 1b (a part (b) of FIG. 9).

Thus, the imaging unit 1a takes the second attitude. This feature makes it possible to contribute to a miniaturization of the camera system 1, and thereby emphasizing storage and the portability.

It is preferable that the camera system that is the first embodiment of the second camera system has a flexible cover member for covering the attitude variable mechanism while permitting the operation of the attitude variable mechanism.

FIG. 10 is a perspective view of a camera system according to a first embodiment of the second camera system of the present invention, having a cover section.

In the event that the cover section 30a, which is adopted in the camera system that is the second embodiment of the first camera system, is adopted in the camera system that is the first embodiment of the second camera system, when a user draws out the imaging unit 1a of the camera system 1 that takes the first attitude in a direction of an arrow A, an elastic member 310a expands as shown in a part (a) of FIG. 10. Here, at the part (a) of FIG. 10, the imaging unit 1a is drawn out forward of the optical axis direction though it hides oneself and it doesn't see it.

Next, it is bent by about 90 degrees by the user so that the elastic member 310a is adjacent to the front side 11b of the camera main frame 1b (a part (b) of FIG. 10). Here, at the part (b) of FIG. 10, it is bent by about 90 degrees so that the side of the imaging unit 1a is adjacent to the front side 11b of the camera main frame 1b, though it hides oneself and it doesn't see it.

Having the cover section 30a makes it possible that the attitude variable mechanism mentioned above is not seen, and it is excellent in the design and high quality can be impressed.

The camera system 1 that is the first embodiment of the second camera system has a sensor (not illustrated) for detecting whether the imaging unit 1a takes the first attitude or the second attitude. The camera system 1 further has power source control means for controlling the power source in accordance with the detection result of the sensor in such a way that the power source is turned on when the first attitude and turned off when the second attitude.

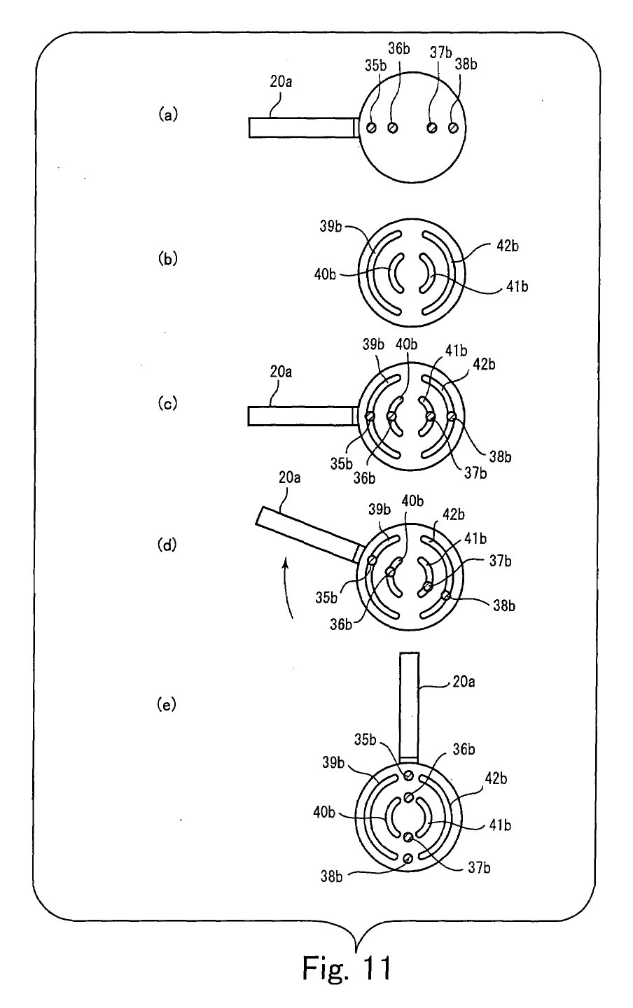

FIG. 11 is an explanatory view useful for understanding power source control means.

A part (a) of FIG. 11 is a top view of the mounting section 2b. The mounting section 2b has four mounting contact terminals 35b, 36b, 37b and 38b.

On the other hand, the second projection section 31b has four arc-like shaped terminals 39b, 40b, 41b and 42b (a part (b) of FIG. 11).

When the imaging unit 1a takes the first attitude, as shown in a part (c) of FIG. 11, the mounting contact terminals 35b, 36b, 37b and 38b contact with the arc-like shaped terminals 39b, 40b, 41b and 42b, respectively, so that the imaging unit 1a is electrically connected with the camera main frame 1b. This state corresponds to the state that a mount contact 10a of the imaging unit 1a side in FIG. 6 is connected with a mount contact 10a of the camera main frame 1b side.

For convenience of the explanation, there are illustrated four mounting contact terminals and four arc-like shaped terminals. It is noted, however, that the number of terminals is not restricted to four, and any one is acceptable.

Moreover, as shown in a part (d) of FIG. 11, in the attitude of the state that the imaging unit 1a takes between the first attitude and the second attitude, in a similar to that of the first attitude, the mounting contact terminals 35b, 36b, 37b and 38b contact with the arc-like shaped terminals 39b, 40b, 41b and 42b, respectively, so that the imaging unit 1a is electrically connected with the camera main frame 1b.

When the user bends the imaging unit 1a to the second attitude, as shown in a part (e) of FIG. 11, the mounting contact terminals 35b, 36b, 37b and 38b does not contact with the arc-like shaped terminals 39b, 40b, 41b and 42b, respectively, so that the sensor decides that the imaging unit 1a is electrically disconnected with the camera main frame 1b, and thereby turning off the power source of the camera main frame 1b.

When the imaging unit 1a changes its attitude from the first attitude to the second attitude, the sensor turns on the power source of the camera main frame 1b.

The explanation of the camera system that is the first embodiment of the second camera system is ended above.

Next, there will be explained a camera system that is the first embodiment of the third camera system.

In the camera system that is the first embodiment of the third camera system, the same parts are denoted by the same reference numbers as those of the camera system that is the first embodiment of the first camera system, and redundant explanation will be omitted.

The camera system that is the first embodiment of the third camera system comprises: the imaging unit; the camera main frame; and an intermediate member for changing the direction of the imaging unit, the intermediate member being interposed between the imaging unit and the camera main frame so that the imaging unit is detachably mounted on the camera main frame, and being adapted for turning the imaging unit.

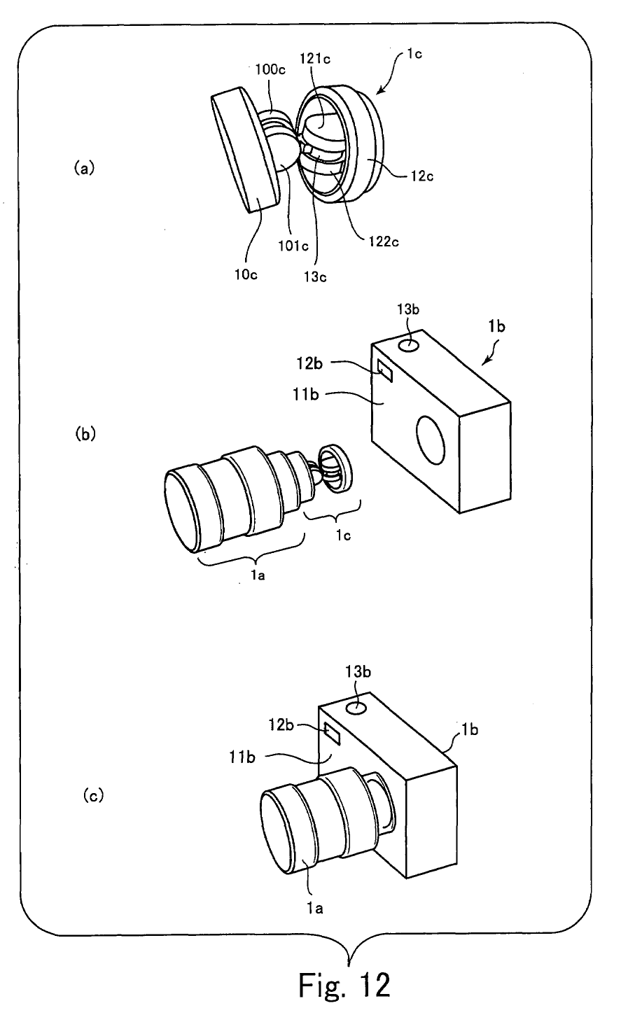

FIG. 12 is an explanatory view useful for understanding a state that the imaging unit is mounted on the camera main frame via the intermediate member.

A part (a) of FIG. 12 is a perspective view of the intermediate member.

An intermediate member 1c comprises a camera main frame joint section 12c that is a first mounting section, a coupling section 11c, and an imaging unit joint section 10c that is a second mounting section.

The imaging unit joint section 10c is to be mounted on the imaging unit 1a. The imaging unit joint section 10c has connecting sections 100c and 101c. The connecting sections 100c and 101c have the same structure as the connecting sections 22a and 23a of the first camera system.

The coupling section 11c is interposed between the imaging unit joint section 10c and the camera main frame joint section 12c, and is adapted for turning the imaging unit 1a. The coupling section 11c has the same structure as the turning material 20a of the first camera system.

The camera main frame joint section 12c is to be mounted on the camera main frame 1b. The camera main frame joint section 12c has a first projection section 121c and a second projection section 122c. The first projection section 121c and the second projection section 122c have the same structure as the first projection section 30b and the second projection section 31b of the first camera system.

Next, there will be explained a structure in which the imaging unit 1a is mounted via the intermediate member 1c on the camera main frame 1b.

First of all, the camera main frame joint section 12c of the intermediate member 1c is mounted on the imaging unit 1a in such a way that it is set in the imaging unit 1a (a part (b) of FIG. 12).

On the other hand, the camera main frame joint section 12c of the intermediate member 1c is mounted on the camera main frame 1b in such a way that it is set in the mounting section of the front side of the camera main frame 1b. Thus, the electrical connection is also implemented.

A part (c) of FIG. 12 is a view showing a state after the imaging unit is mounted on the camera main frame via the intermediate member.

Thus, when the imaging unit is mounted on the camera main frame via the intermediate member, a user can turn around the imaging unit by turning the imaging unit, and thereby simply performing the pan adjustment and the tilt adjustment. Therefore, according to the present embodiment, it is possible to contribute to an improvement of operability in adjustment.

Next, there will be explained an attitude variable mechanism of the imaging unit 1a of the third camera system.

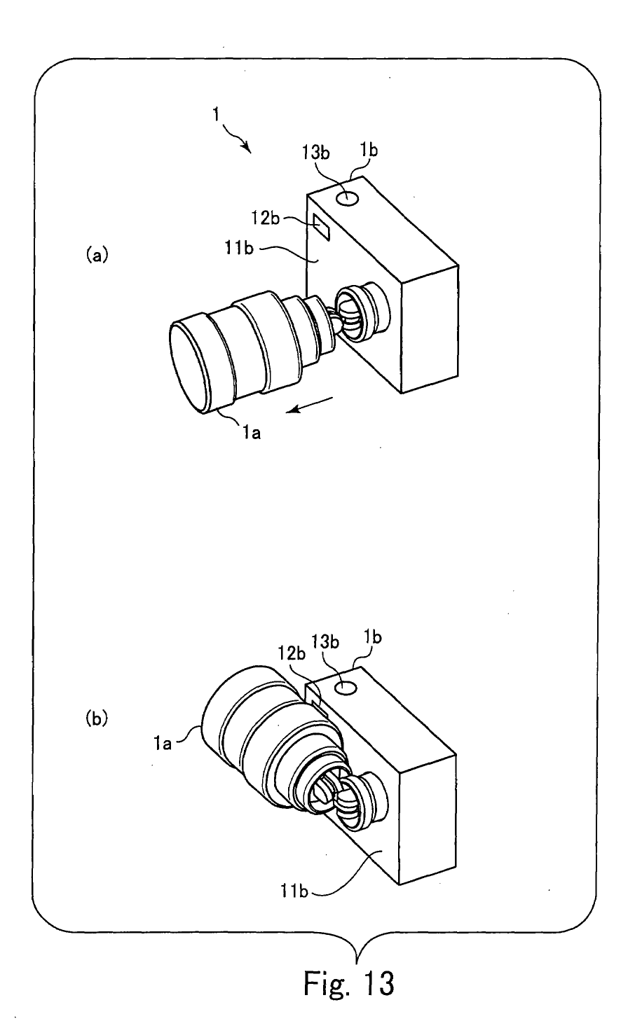

FIG. 13 is an explanatory view useful for understanding an attitude variable mechanism of the imaging unit.

When a user draws out the imaging unit 1a of the camera system 1, which takes the first attitude, in the direction of arrow A, as shown in a part (a) of FIG. 13, the imaging unit 1a is drawn out forward of the optical axis direction.

Next, it is bent by about 90 degrees by the user so that the side of the imaging unit 1a is adjacent to the front side 11b of the camera main frame 1b.

Thus, the imaging unit 1a takes the second attitude. This feature makes it possible to contribute to a miniaturization of the camera system 1, and thereby emphasizing storage and the portability.

It is acceptable that that the third camera system also has a flexible cover member for covering the intermediate member 1c while permitting the operation of the intermediate member 1c, in a similar fashion to that of the second camera system.

This feature makes it possible that the intermediate member 1c is not seen, and it is excellent in the design and high quality can be impressed.

It is acceptable that the third camera system has a sensor for detecting whether the imaging unit 1a takes the first attitude or the second attitude. The camera system further has power source control means for controlling the power source in accordance with the detection result of the sensor in such a way that the power source is turned on when the first attitude and turned off when the second attitude.

Having the power source control means makes it possible to avoid useless power consumption because the power supply is automatically turned off in the state that exists in the second attitude.

As mentioned above, according to the camera system of the present invention there is provided a camera system which contributes to an improvement of operability when the composition is adjusted.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A camera system comprising:
an imaging unit that incorporates therein an imaging device, the imaging unit forming an image of a subject on the imaging device to generate image data;
a camera main frame on which the imaging unit is detachably mounted, the camera main frame receiving an image signal generated in the imaging device of the imaging unit to perform signal processing; and
a turning mechanism that turns the imaging unit by turning the imaging unit which is mounted on the camera main frame.

2. A camera system according to claim 1, further comprising a flexible cover section that covers the turning mechanism while permitting an operation of the turning mechanism.

3. A camera system comprising:
an imaging unit that incorporates therein an imaging device, the imaging unit forming an image of a subject on the imaging device to generate image data;
a camera main frame on which the imaging unit is detachably mounted, the camera main frame receiving an image signal generated in the imaging device of the imaging unit to perform signal processing; and
an attitude variable mechanism that changes attitude of the imaging unit mounted on the camera main frame between a first attitude wherein the imaging unit turns to the subject against the back of the camera main frame and a second attitude wherein the side of the imaging unit approaches the subject side of the camera main frame.

4. A camera system according to claim 3, further comprising a flexible cover section that covers the attitude variable mechanism while permitting an operation of the attitude variable mechanism.

5. A camera system according to claim 3, wherein the imaging unit has a mounting section that is in charge of coupling with the camera main frame, and an imaging unit main frame in which a coupling structure with the mounting section serves as the attitude variable mechanism, and the imaging unit is drawn out forward of an optical axis direction while the mounting section is left in a state that the imaging unit is mounted on the camera main frame, so that the imaging unit changes to the second attitude.

6. A camera system according to claim 3, further comprising a sensor that detects whether the imaging unit takes the first attitude or the second attitude, and power source control means for controlling a power source in accordance with a detection result of the sensor in such a way that the power source is turned on when the first attitude and turned off when the second attitude.

7. A camera system comprising:
an imaging unit that incorporates therein an imaging device, the imaging unit forming an image of a subject on the imaging device to generate image data;
a camera main frame on which the imaging unit is detachably mounted, the camera main frame receiving an image signal generated in the imaging device of the imaging unit to perform signal processing; and
an intermediate member that turns the imaging unit, the intermediate member being interposed between the imaging unit and the camera main frame so that the imaging unit is detachably mounted on the camera main frame, and being adapted for turning the imaging unit.

8. A camera system according to claim 7, further comprising a flexible cover section that covers the intermediate member while permitting an operation of the intermediate member.

9. A camera system according to claim 7, wherein the intermediate member has an attitude variable mechanism that changes attitude of the imaging unit mounted on the camera main frame via the intermediate member between a first attitude wherein the imaging unit turns to the subject against the back of the camera main frame and a second attitude wherein the side of the imaging unit approaches the subject side of the camera main frame.

10. A camera system according to claim 9, wherein the intermediate member has a first mounting section that is in charge of coupling with the camera main frame, a second mounting section that is in charge of coupling with the imaging unit, and a coupling structure that serves as the attitude variable mechanism, wherein the second mounting section is drawn out forward of an optical axis direction while the first mounting section is left in a state that the imaging unit is mounted on the camera main frame via the intermediate member, so that the imaging unit changes to the second attitude.

11. A camera system according to claim 7, wherein the intermediate member has a sensor that detects whether the imaging unit takes the first attitude or the second attitude, and
the camera system further comprises power source control means for controlling a power source in accordance with a detection result of the sensor in such a way that the power source is turned on when the first attitude and turned off when the second attitude.
